(19) United States
(12) Patent Application Publication
(10) Pub. No.: US 2013/0163640 A1
(43) Pub. Date: Jun. 27, 2013

(54) RFID READERS CO-EXISTING WITH OTHER ISM-BAND DEVICES

(71) Applicant: Impinj, Inc., Seattle, WA (US)

(72) Inventors: Ali Aiouaz, Mission Viejo, CA (US); Christopher J. Diorio, Shoreline, WA (US); Aanand Esterberg, Seattle, WA (US); Harsh Jain, Irvine, CA (US); Omar Khwaja, Irvine, CA (US); David Ord, Aliso Viejo, CA (US); Mike Thomas, Wake Forest, NC (US)

(73) Assignee: Impinj, Inc., Seattle, WA (US)

(21) Appl. No.: 13/778,110

(22) Filed: Feb. 26, 2013

Related U.S. Application Data
(62) Division of application No. 12/056,120, filed on Mar. 26, 2008.
(60) Provisional application No. 60/925,345, filed on Apr. 18, 2007.
(60) Provisional application No. 60/925,752, filed on Apr. 23, 2007.
(60) Provisional application No. 61/019,948, filed on Jan. 9, 2008.

(51) Int. Cl. H04B 1/715; H04B 5/00

(52) U.S. Cl. CPC H04B 1/715; H04B 5/0062
USPC 375/133

(57) ABSTRACT

Radio Frequency IDentification (RFID) reader system, software, and methods are provided, such that an operational processing block for the RFID reader to communicate with an RFID tag uses a RF spectrum portion subdivided into a set of channels. The communication takes place in the presence of a foreign device that uses a subset of first channels of the RF spectrum and does not use a subset of second channels of the spectrum. The methods cause a radiating power directed towards the tag to be reduced and a radiating dwell time to be changed. This is to assure that co-existing systems can operate without compromising their functionality and operational quality. In some embodiments, the radiating power is reduced to zero.

### CROSS REFERENCE TO RELATED APPLICATIONS

This application claims priority from U.S.A. Provisional Application Ser. No. 60/925,345, filed on Apr. 18, 2007, the disclosure of which is hereby incorporated by reference for all purposes.

This application claims priority from U.S.A. Provisional Application Ser. No. 60/925,752, filed on Apr. 23, 2007, the disclosure of which is hereby incorporated by reference for all purposes.

This application claims priority from U.S.A. Provisional Application Ser. No. 61/019,948, filed on Jan. 9, 2008, the disclosure of which is hereby incorporated by reference for all purposes.

### FIELD OF THE INVENTION

The present description addresses the field of Radio Frequency IDentification (RFID) systems, and more specifically RFID reader systems, software and methods where RFID readers co-exist with other ISM-band devices.

### BACKGROUND

Radio Frequency IDentification (RFID) systems typically include RFID tags and RFID readers. RFID readers are also known as RFID reader/writers or RFID interrogators. RFID systems can be used in many ways for locating and identifying objects to which the tags are attached. RFID systems are particularly useful in product-related and service-related industries for tracking objects being processed, inventoried, or handled. In such cases, an RFID tag is usually attached to an individual item, or to its package.

In principle, RFID techniques entail using an RFID reader to interrogate one or more RFID tags. The reader performs the interrogation by transmitting a Radio Frequency (RF) wave. The RF wave is typically electromagnetic, at least in the far field. The RF wave can also be predominantly electric or magnetic in the near field.

A tag that senses the interrogating RF wave responds by transmitting back another RF wave. The tag generates the transmitted back RF wave either originally, or by reflecting back a portion of the interrogating RF wave in a process known as backscatter. Backscatter may take place in a number of ways.

The reflected-back RF wave may further encode data, such as a number, stored internally in the tag. The response is demodulated and decoded by the reader, which thereby identifies, counts, or otherwise interacts with the associated item. The decoded data can denote a serial number, a price, a date, a destination, other attribute(s), any combination of attributes, and so on.

An RFID tag typically includes an antenna system, a radio section, a power management section, and frequently a logical section, a memory, or both. In earlier RFID tags, the power management section included an energy storage device, such as a battery. RFID tags with energy storage devices are known as active or semi-active tags. Advances in semiconductor technology have miniaturized the electronics so much that an RFID tag can be powered solely by the RF signal it receives. Such RFID tags do not include an energy storage device, and are called passive tags.

In some cases, RFID systems operate in an environment where other ISM band devices use a subset of the ISM band. It is desired to have the different systems co-exist with one and other without compromising the quality and functionality of operations.

### BRIEF SUMMARY

Radio Frequency IDentification (RFID) reader systems, software and methods are provided, for communicating with an RFID tag using a RF spectrum portion subdivided into a set of channels. The communication takes place in the presence of a foreign device that uses a subset of first channels of the RF spectrum and does not use a subset of second channels of the spectrum. In some embodiments, power directed towards the tag is reduced in the first channels compared to the second channels. In some embodiments, a dwell time in the first channels is less than corresponding dwell time in the second embodiments.

The invention offers the advantage that an RFID reader system can co-exist with a foreign device operating in an ISM band, without compromising its functionality or operational quality.

These and other features and advantages of the invention will be better understood from the specification of the invention, which includes the following Detailed Description and accompanying Drawings.

### BRIEF DESCRIPTION OF THE DRAWINGS

The following Detailed Description proceeds with reference to the accompanying Drawings, in which:

FIG. 1 is a block diagram of components of an RFID system.

FIG. 2 is a diagram showing components of a passive RFID tag, such as a tag that can be used in the system of FIG. 1.

FIG. 3 is a conceptual diagram explaining a half-duplex mode of communication between the components of the RFID system of FIG. 1.

FIG. 4 is a block diagram showing details of an RFID reader system, such as the one shown in FIG. 1.

FIG. 5 is a block diagram of a whole RFID reader system according to embodiments.

FIG. 6 is a block diagram illustrating an overall architecture of an RFID reader system according to embodiments.

FIG. 7A is a block diagram illustrating RFID readers co-existing with other ISM-band devices according to embodiments of the present invention.

FIG. 7B is a flowchart illustrating methods of operating a RFID reader system according to embodiments of the present invention.

FIG. 7C is a flowchart illustrating methods for an operation of the flowchart of FIG. 7B according to embodiments of the present invention.

FIG. 7D is a flowchart illustrating methods for an operation of the flowchart of FIG. 7B according to embodiments of the present invention.

FIG. 7E is a flowchart illustrating methods for an operation of the flowchart of FIG. 7C according to embodiments of the present invention.

FIG. 8A is a diagram illustrating an example of channel distribution in a subset of the RF spectrums according to prior art.

FIG. 8B is a diagram illustrating an example of use of channels of FIG. 8A by a foreign device according to an embodiment of the present invention.

FIG. 8C is a diagram illustrating an example of an RFID reader use of channels of FIG. 8A respecting the channels of FIG. 8B of a foreign device, according to embodiments of the present invention.

FIG. 9 is a table illustrating an example of signal strength status in channels that are shared and not shared with the foreign device according to an embodiment of the present invention.

FIG. 10A is a timing diagram illustrating an example of continuous dwelling in a channel occupied by a foreign device, according to an embodiment of the present invention.

FIG. 10B is a timing diagram illustrating an example of fractured dwelling in a channel occupied by a foreign device, according to an embodiment of the present invention.

FIGS. 11A-F are diagrams illustrating examples of various fractured hopping sequences according to embodiments of the present invention.

FIG. 12 is a diagram illustrating an example of two foreign devices and RFID systems' use of subsets of an RF spectrum.

### DETAILED DESCRIPTION

The present invention is now described. While it is disclosed in its preferred form, the specific embodiments of the invention as disclosed herein and illustrated in the drawings are not to be considered in a limiting sense. Rather, these embodiments are provided so that this disclosure will be thorough and complete, and will fully convey the scope of the invention to those skilled in the art. Indeed, it should be readily apparent in view of the present description that the invention may be modified in numerous ways. Among other things, the present invention may be embodied as devices, methods, software, and so on. Accordingly, the present invention may take the form of an entirely hardware embodiment, an entirely software embodiment, an entirely firmware embodiment, or an embodiment combining aspects of the above. This description is, therefore, not to be taken in a limiting sense.

As has been mentioned, the present invention provides for Radio Frequency IDentification (RFID) reader system, software, and methods, where RFID readers co-exist with other ISM-band devices.

The invention is now described in more detail.

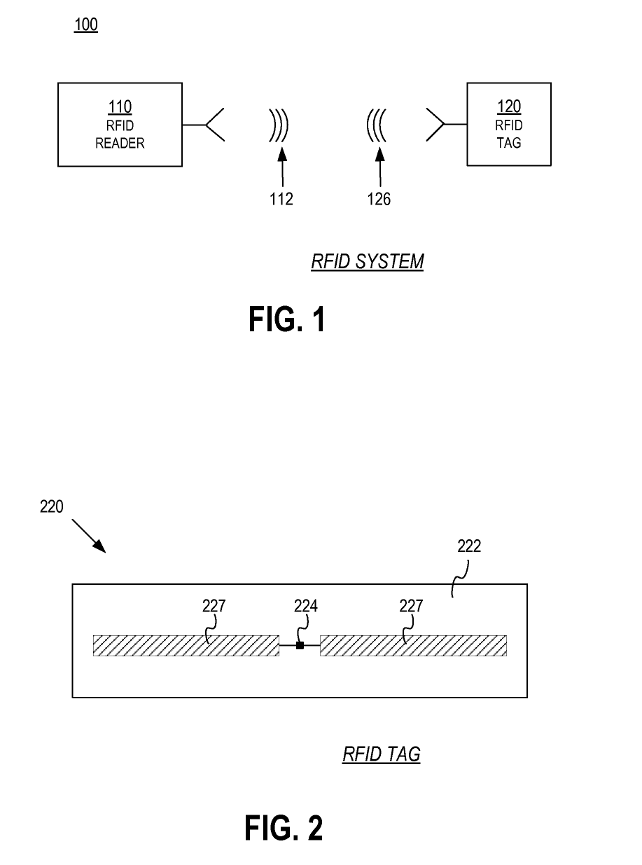

FIG. 1 is a diagram of components of a typical RFID system 100, incorporating aspects of the invention. An RFID reader 110 transmits an interrogating Radio Frequency (RF) wave 112. RFID tag 120 in the vicinity of RFID reader 110 may sense interrogating RF wave 112, and generate wave 126 in response. RFID reader 110 senses and interprets wave 126.

Reader 110 and tag 120 exchange data via wave 112 and wave 126. In a session of such an exchange, each encodes, modulates, and transmits data to the other, and each receives, demodulates, and decodes data from the other. The data is modulated onto, and demodulated from, RF waveforms.

Encoding the data in waveforms can be performed in a number of different ways. For example, protocols are devised to communicate in terms of symbols, also called RFID symbols. A symbol for communicating can be a delimiter, a calibration symbol, and so on. Further symbols can be implemented for ultimately exchanging binary data, such as “0” and “1”, if that is desired. In turn, when the waveforms are processed internally by reader 110 and tag 120, they can be equivalently considered and treated as numbers having corresponding values, and so on.

Tag 120 can be a passive tag or an active or semi-active tag, i.e. having its own power source. Where tag 120 is a passive tag, it is powered from wave 112.

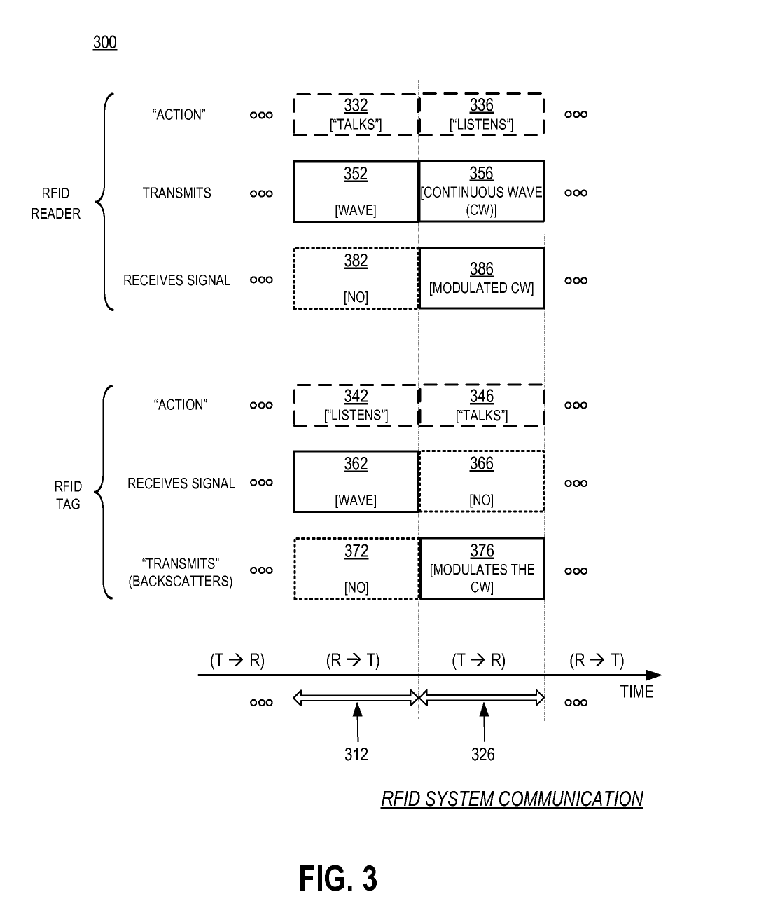

FIG. 2 is a diagram of an RFID tag 220, which can be the same as tag 120 of FIG. 1. Tag 220 is implemented as a passive tag, meaning it does not have its own power source. Much of what is described in this document, however, applies also to active tags.

Tag 220 is formed on a substantially planar inlay 222, which can be made in many ways known in the art. Tag 220 includes an electrical circuit, which is preferably implemented in an integrated circuit (IC) 224. IC 224 is arranged on inlay 222.

Tag 220 also includes an antenna for exchanging wireless signals with its environment. The antenna is usually flat and attached to inlay 222. IC 224 is electrically coupled to the antenna via suitable antenna ports (not shown in FIG. 2).

The antenna may be made in a number of ways, as is well known in the art. In the example of FIG. 2, the antenna is made from two distinct antenna segments 227, which are shown here forming a dipole. Many other embodiments are possible, using any number of antenna segments.

In some embodiments, an antenna can be made with even a single segment. Different points of the segment can be coupled to one or more of the antenna ports of IC 224. For example, the antenna can form a single loop, with its ends coupled to the ports. It should be remembered that, when the single segment has more complex shapes, even a single segment could behave like multiple segments, at the frequencies of RFID wireless communication.

In operation, a signal is received by the antenna, and communicated to IC 224. IC 224 both harvests power, and responds if appropriate, based on the incoming signal and its internal state. In order to respond by replying, IC 224 modulates the reflectance of the antenna, which generates the backscatter from a wave transmitted by the reader.

Coupling together and uncoupling the antenna ports of IC 224 can modulate the reflectance, as can a variety of other means.

In the embodiment of FIG. 2, antenna segments 227 are separate from IC 224. In other embodiments, antenna segments may alternately be formed on IC 224, and so on.

The components of the RFID system of FIG. 1 may communicate with each other in any number of modes. One such mode is called full duplex. Another such mode is called half-duplex, and is described below.

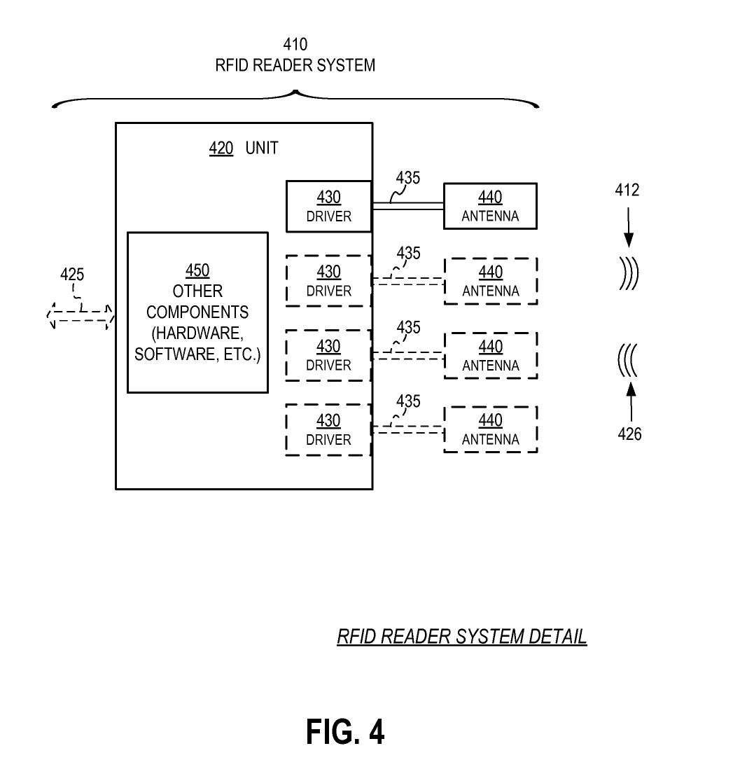

FIG. 3 is a conceptual diagram 300 for explaining the half-duplex mode of communication between the components of the RFID system of FIG. 1, especially when tag 120 is implemented as passive tag 220 of FIG. 2. The explanation is made with reference to a TIME axis, and also to a human metaphor of “talking” and “listening”. The actual technical implementations for “talking” and “listening” are now described.

RFID reader 110 and RFID tag 120 talk and listen to each other by taking turns. As seen on axis TIME, when reader 110 talks to tag 120 the communication session is designated as “R→T”, and when tag 120 talks to reader 110 the communication session is designated as “T→R”. Along the TIME axis, a sample R→T communication session occurs during a time interval 312, and a following sample T→R communication session occurs during a time interval 326. Of course interval 312 is typically of a different duration than interval 326—here the durations are shown approximately equal only for purposes of illustration.

According to blocks 332 and 336, RFID reader 110 talks during interval 312, and listens during interval 326. According to blocks 342 and 346, RFID tag 120 listens while reader 110 talks (during interval 312), and talks while reader 110 listens (during interval 326).

In terms of actual technical behavior, during interval 312, reader 110 talks to tag 120 as follows. According to block 352, reader 110 transmits wave 112, which was first described in FIG. 1. At the same time, according to block 362, tag 120 receives wave 112 and processes it, to extract data and so on. Meanwhile, according to block 372, tag 120 does not backscatter with its antenna, and according to block 382, reader 110 has no wave to receive from tag 120.

During interval 326, tag 120 talks to reader 110 as follows. According to block 356, reader 110 transmits a Continuous Wave (CW), which can be thought of as a carrier signal that ideally encodes no information. As discussed before, this carrier signal serves both to be harvested by tag 120 for its own internal power needs, and also as a wave that tag 120 can backscatter. Indeed, during interval 326, according to block 366, tag 120 does not receive a signal for processing. Instead, according to block 376, tag 120 modulates the CW emitted according to block 356, so as to generate backscatter wave 126. Concurrently, according to block 386, reader 110 receives backscatter wave 126 and processes it.

In the above, an RFID reader/interrogator may communicate with one or more RFID tags in any number of ways. Some such ways are called protocols. A protocol is a specification that calls for specific manners of signaling between the reader and the tags.

One such protocol is called the Specification for RFID Air Interface—EPC™ Radio-Frequency Identity Protocols Class-1 Generation-2 UHF RFID Protocol for

Communications at 860 MHz-960 MHz, which is also colloquially known as “the Gen2 Spec”. The Gen2 Spec has been ratified by EPCglobal, which is an organization that maintains a website at: <http://www.epcglobalinc.org/> at the time this document is initially filed with the USPTO.

In addition, a protocol can be a variant of a stated specification such as the Gen2 Spec, for example including fewer or additional commands than the stated specification calls for, and so on. In such instances, additional commands are sometimes called custom commands

It was described above how reader 110 and tag 120 communicate in terms of time. In addition, communications between reader 110 and tag 120 may be restricted according to frequency. One such restriction is that the available frequency spectrum may be partitioned into divisions that are called channels. Different partitioning manners may be specified by different regulatory jurisdictions and authorities (e.g. FCC in North America, CEPT in Europe, etc.).

Reader 110 typically transmits with a transmission spectrum that lies within one channel. In some regulatory jurisdictions the authorities permit aggregating multiple channels into one or more larger channels, but for all practical purposes an aggregate channel can again be considered a single, albeit larger, individual channel.

Tag 120 can respond with a backscatter that is modulated directly onto the frequency of the reader's emitted CW, also called baseband backscatter. Alternatively, tag 120 can respond with a backscatter that is modulated onto a frequency, developed by tag 120, that is different from the reader's emitted CW, and this modulated tag frequency is then impressed upon the reader's emitted CW. This second type of backscatter is called subcarrier backscatter. The subcarrier frequency can be within the reader's channel, can straddle the boundaries with the adjacent channel, or can be wholly outside the reader's channel.

A number of jurisdictions require a reader to hop to a new channel on a regular basis. When a reader hops to a new channel, it may encounter RF energy there that could interfere with communications.

Embodiments of the present disclosure can be useful in different RFID environments, for example, in the deployment of RFID readers in sparse- or dense-reader environments, in environments with networked and disconnected readers such as where a hand-held reader may enter the field of networked readers, in environments with mobile readers, or in environments with other interference sources. It will be understood that the present embodiments are not limited to operation in the above environments, but may provide improved operation in such environments.

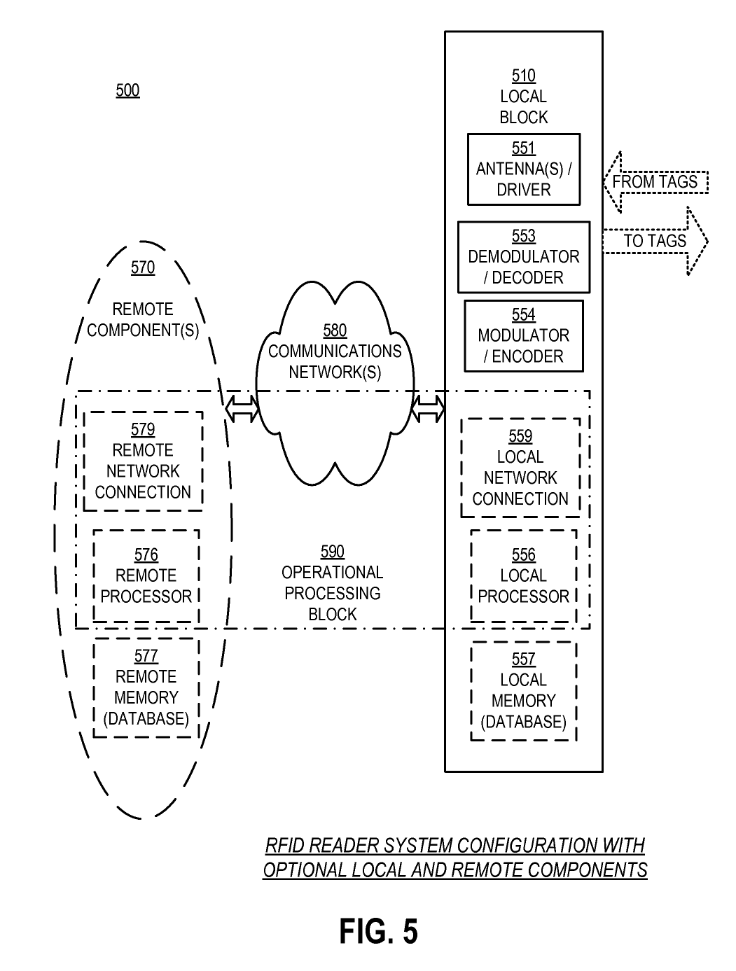

FIG. 4 is a block diagram showing a detail of an RFID reader system 410, which can be the same as reader 110 shown in FIG. 1. A unit 420 is also known as a box 420, and has at least one antenna driver 430. In some embodiments, it has four drivers 430. For each driver 430 there is an output device for a connector. The output device is typically a coaxial cable plug. Accordingly, connectors 435 can be attached to the output devices of the provided respective drivers 430, and then connectors 435 can be attached to respective antennas 440.

A driver 430 can send to its respective antenna 440 a driving signal that is in the RF range, which is why connector 435 is typically but not necessarily a coaxial cable. The driving signal causes the antenna 440 to transmit an RF wave 412, which is analogous to RF wave 112 of FIG. 1. In addition, RF wave 426 can be backscattered from the RFID tags, analogous to RF wave 126 of FIG. 1. Backscattered RF wave 426 then ultimately becomes a signal sensed by unit 420.

Unit 420 also has other components 450, such as hardware and/or software and/or firmware, which may be described in more detail later in this document. Components 450 control drivers 430, and as such cause RF wave 412 to be transmitted, and the sensed backscattered RF wave 426 to be interpreted. Optionally and preferably, there is a communication link 425 to other equipment, such as computers and the like, for remote operation of system 410.

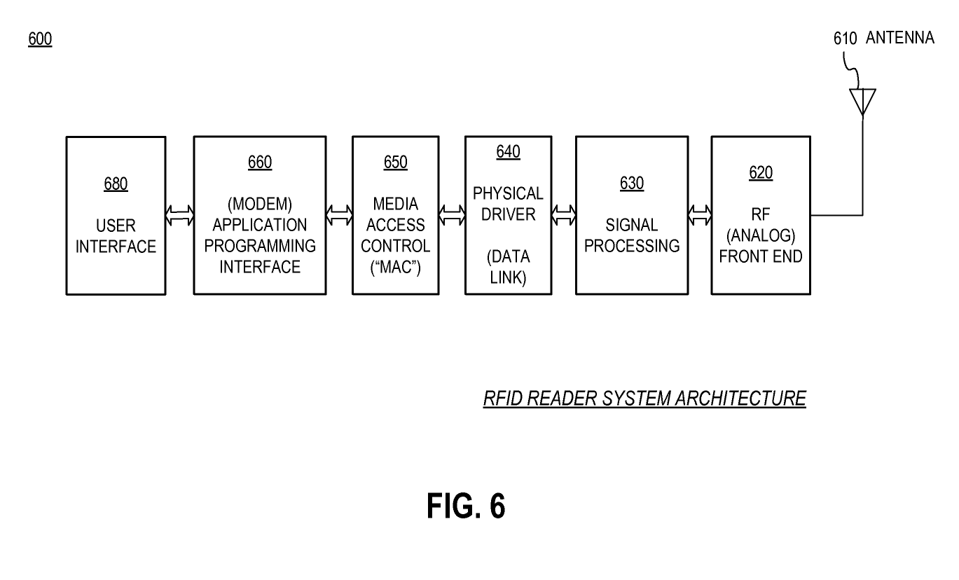

FIG. 5 is a block diagram of a whole RFID reader system 500 according to embodiments. System 500 includes a local block 510, and optionally remote components 570. Local block 510 and remote components 570 can be implemented in any number of ways. It will be recognized that reader 110 of FIG. 1 is the same as local block 510, if remote components 570 are not provided. Alternately, reader 110 can be implemented instead by system 500, of which only the local block 510 is shown in FIG. 1. Plus, local block 510 can be unit 420 of FIG. 4.

Local block 510 is responsible for communicating with the tags. Local block 510 includes a block 551 of an antenna and a driver of the antenna for communicating with the tags. Some readers, like that shown in local block 510, contain a single antenna and driver. Some readers contain multiple antennas and drivers and a method to switch signals among them, including sometimes using different antennas for transmitting and for receiving. And some readers contain multiple antennas and drivers that can operate simultaneously. A demodulator/decoder block 553 demodulates and decodes backscattered waves received from the tags via antenna block 551. Modulator/encoder block 554 encodes and modulates an RF wave that is to be transmitted to the tags via antenna block 551.

Local block 510 additionally includes an optional local processor 556. Processor 556 may be implemented in any number of ways known in the art. Such ways include, by way of examples and not of limitation, digital and/or analog processors such as microprocessors and digital-signal processors (DSPs); controllers such as microcontrollers; software running in a machine such as a general purpose computer; programmable circuits such as Field Programmable Gate Arrays (FPGAs), Field-Programmable Analog Arrays (FPAAs), Programmable Logic Devices (PLDs), Application Specific Integrated Circuits (ASIC), any combination of one or more of these; and so on. In some cases some or all of the decoding function in block 553, the encoding function in block 554, or both, may be performed instead by processor 556.

Local block 510 additionally includes an optional local memory 557. Memory 557 may be implemented in any number of ways known in the art. Such ways include, by way of examples and not of limitation, nonvolatile memories (NVM), read-only memories (ROM), random access memories (RAM), any combination of one or more of these, and so on. Memory 557, if provided, can include programs for processor 556 to run, if provided.

In some embodiments, memory 557 stores data read from tags, or data to be written to tags, such as Electronic Product Codes (EPCs), Tag Identifiers (TIDs) and other data. Memory 557 can also include reference data that is to be compared to the EPC codes, instructions, and/or rules for how to encode commands for the tags, modes for controlling antenna 551, and so on. In some of these embodiments, local memory 557 is provided as a database.

Some components of local block 510 typically treat the data as analog, such as the antenna/driver block 551. Other components such as memory 557 typically treat the data as digital. At some point, there is a conversion between analog and digital. Based on where this conversion occurs, a whole reader may be characterized as “analog” or “digital”, but most readers contain a mix of analog and digital functionality.

If remote components 570 are indeed provided, they are coupled to local block 510 via an electronic communications network 580. Network 580 can be a Local Area Network (LAN), a Metropolitan Area Network (MAN), a Wide Area Network (WAN), a network of networks such as the internet, or a mere local communication link, such as a USB, PCI, and so on. In turn, local block 510 then includes a local network connection 559 for communicating with network 580.

There can be one or more remote component(s) 570. If more than one, they can be located at the same location, or in different locations. They can access each other and local block 510 via network 580, or via other similar networks, and so on. Accordingly, remote component(s) 570 can use respective remote network connections. Only one such remote network connection 579 is shown, which is similar to local network connection 559, etc.

Remote component(s) 570 can also include a remote processor 576. Processor 576 can be made in any way known in the art, such as was described with reference to local processor 556.

Remote component(s) 570 can also include a remote memory 577. Memory 577 can be made in any way known in the art, such as was described with reference to local memory 557. Memory 577 may include a local database, and a different database of a Standards Organization, such as one that can reference EPCs.

Of the above-described elements, it is advantageous to consider a combination of these components, designated as operational processing block 590. Block 590 includes those that are provided of the following: local processor 556, remote processor 576, local network connection 559, remote network connection 579, and by extension an applicable portion of network 580 that links connection 559 with connection 579. The portion can be dynamically changeable, etc. In addition, block 590 can receive and decode RF waves received via antenna 551, and cause antenna 551 to transmit RF waves according to what it has processed.

Block 590 includes either local processor 556, or remote processor 576, or both. If both are provided, remote processor 576 can be made such that it operates in a way complementary with that of local processor 556. In fact, the two can cooperate. It will be appreciated that block 590, as defined this way, is in communication with both local memory 557 and remote memory 577, if both are present.

Accordingly, block 590 is location agnostic, in that its functions can be implemented either by local processor 556, or by remote processor 576, or by a combination of both. Some of these functions are preferably implemented by local processor 556, and some by remote processor 576. Block 590 accesses local memory 557, or remote memory 577, or both for storing and/or retrieving data.

Reader system 500 operates by block 590 generating communications for RFID tags. These communications are ultimately transmitted by antenna block 551, with modulator/encoder block 554 encoding and modulating the information on an RF wave. Then data is received from the tags via antenna block 551, demodulated and decoded by demodulator/decoder block 553, and processed by processing block 590.

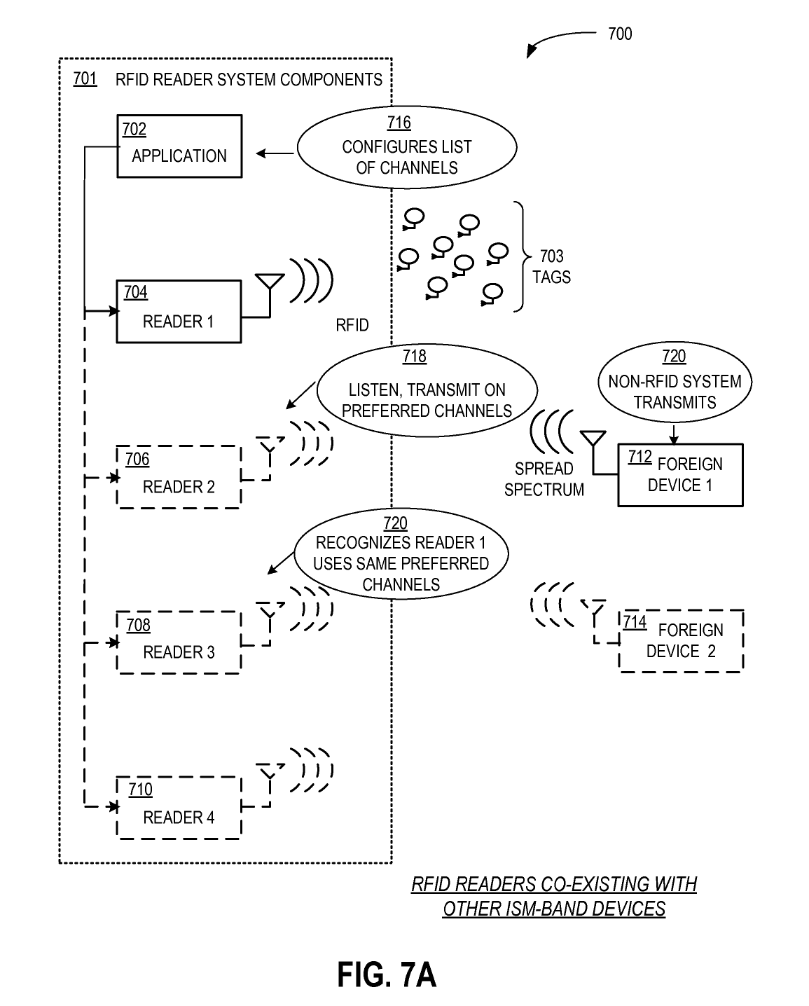

FIG. 6 is a block diagram illustrating an overall architecture of an RFID reader system 600 according to embodiments. It will be appreciated that system 600 is considered subdivided into modules or components. Each of these modules may be implemented by itself, or in combination with others. It will be recognized that some aspects are parallel with those of FIG. 5. In addition, some of them may be present more than once.

RFID reader system 600 includes one or more antennas 610, and an RF Front End 620, for interfacing with antenna(s) 610. These can be made as described above. In addition, Front End 620 typically includes analog components.

System 600 also includes a Signal Processing module 630. In this embodiment, module 630 exchanges waveforms with Front End 620, such as I and Q waveform pairs. In some embodiments, signal processing module 630 is implemented by itself in an FPGA.

System 600 also includes a Physical Driver module 640, which is also known as Data Link. In this embodiment, module 640 exchanges bits with module 630. Data Link 640 can be the stage associated with framing of data. In one embodiment, module 640 is implemented by a Digital Signal Processor.

System 600 additionally includes a Media Access Control module 650, which is also known as MAC layer. In this embodiment, module 650 exchanges packets of bits with module 640. MAC layer 650 can be the stage for making decisions for sharing the medium of wireless communication, which in this case is the air interface. Sharing can be between reader system 600 and tags, or between system 600 with another reader, or between tags, or a combination. In one embodiment, module 650 is implemented by a Digital Signal Processor.

System 600 moreover includes an Application Programming Interface module 660, which is also known as API, Modem API, and MAPI. In some embodiments, module 660 is itself an interface for a user.

All of these functionalities can be supported by one or more processors. One of these processors can be considered a host processor. Such a processor would, for example, exchange signals with MAC layer 650 via module 660. In some embodiments, the processor can include applications for system 600. In some embodiments, the processor is not considered as a separate module, but one that includes some of the above-mentioned modules of system 600.

A user interface 680 may be coupled to API 660. User interface 680 can be manual, automatic, or both. It can be supported by a separate processor than the above mentioned processor, or implemented on it.

It will be observed that the modules of system 600 form something of a chain. Adjacent modules in the chain can be coupled by the appropriate instrumentalities for exchanging signals. These instrumentalities include conductors, buses, interfaces, and so on. These instrumentalities can be local, e.g. to connect modules that are physically close to each other, or over a network, for remote communication.

The chain is used in opposite directions for receiving and transmitting. In a receiving mode, wireless waves are received by antenna(s) 610 as signals, which are in turn processed successively by the various modules in the chain. Processing can terminate in any one of the modules. In a transmitting mode, initiation can be in any one of these modules. Ultimately, signals are transmitted internally, for antenna(s) 610 to transmit as wireless waves.

The architecture of system 600 is presented for purposes of explanation, and not of limitation. Its particular subdivision into modules need not be followed for creating embodiments according to the invention. Furthermore, the features of the invention can be performed either within a single one of the modules, or by a combination of them.

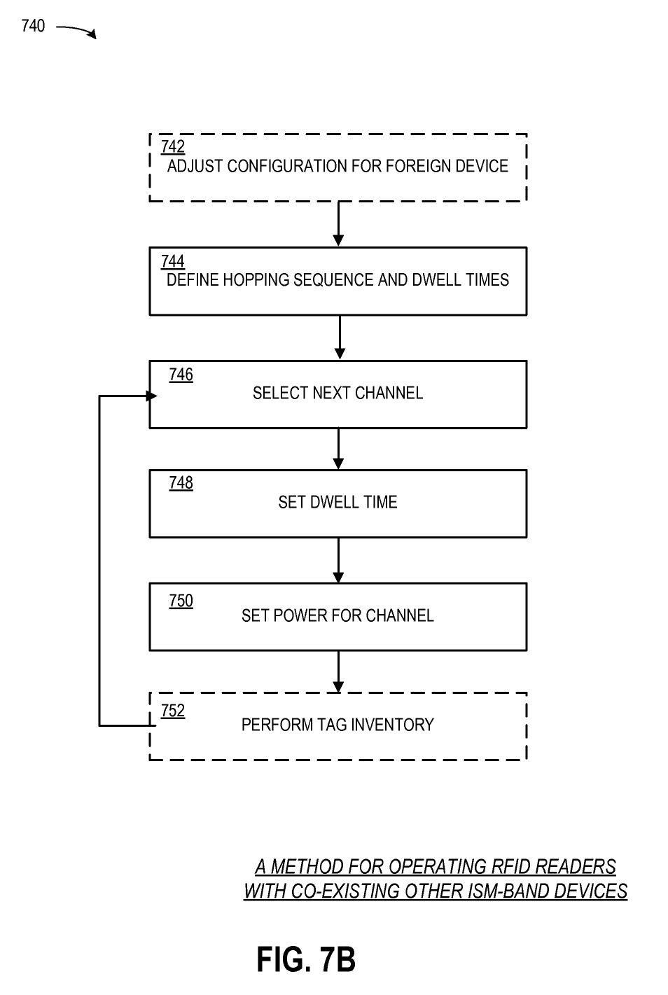

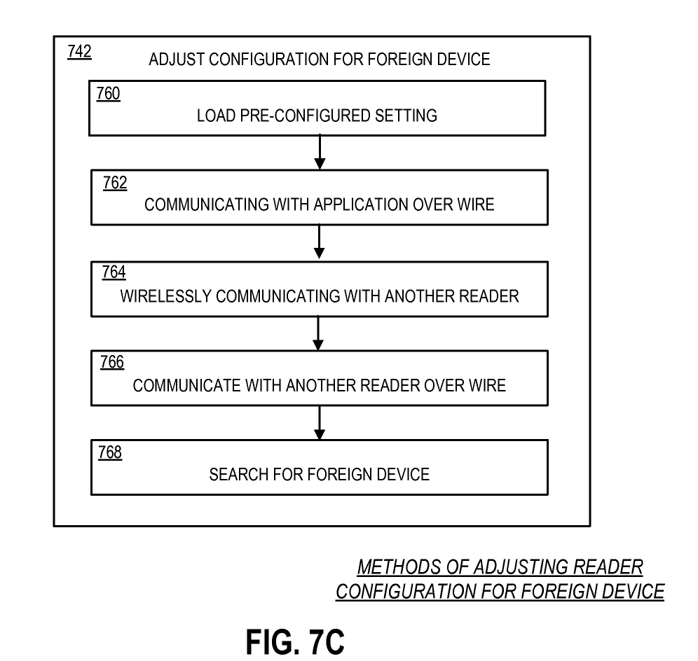

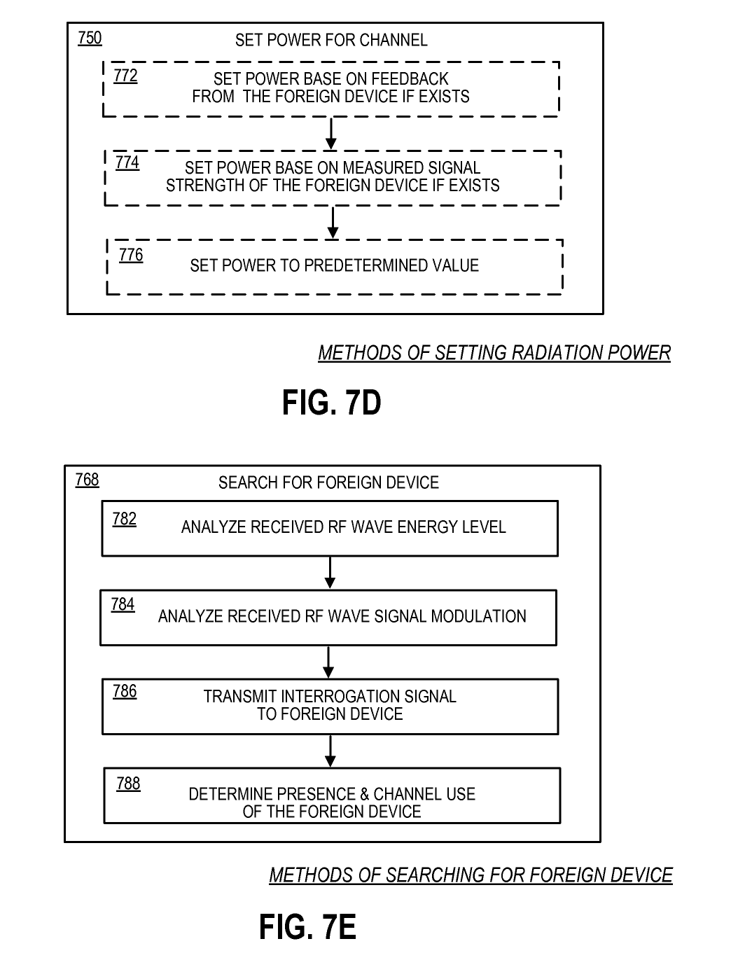

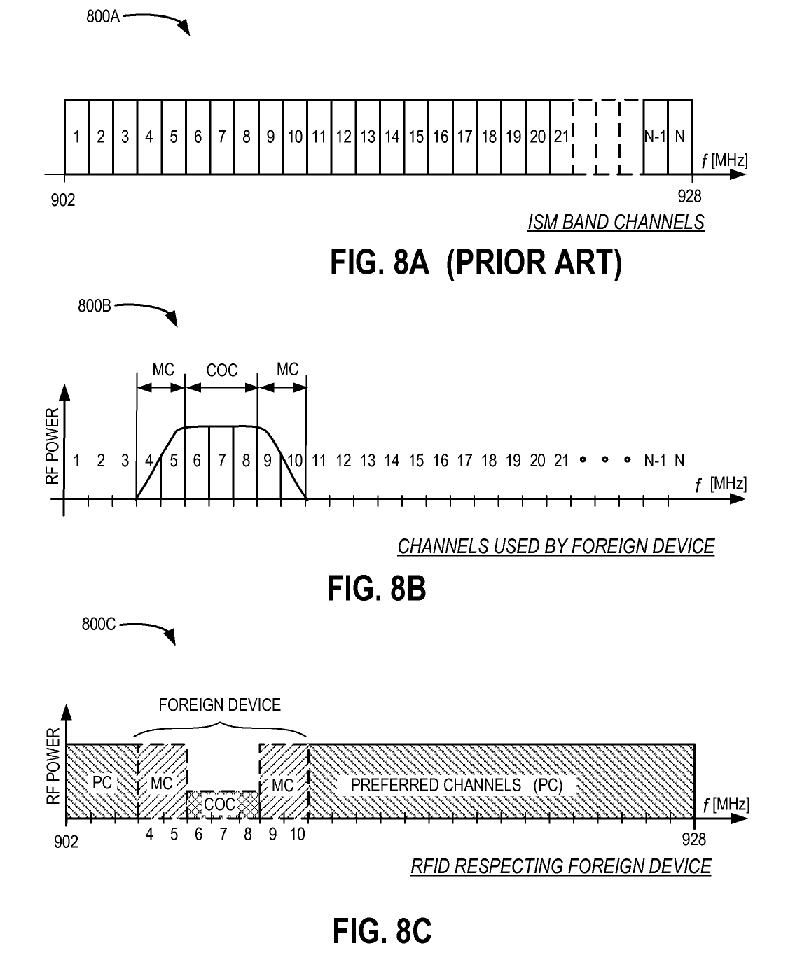

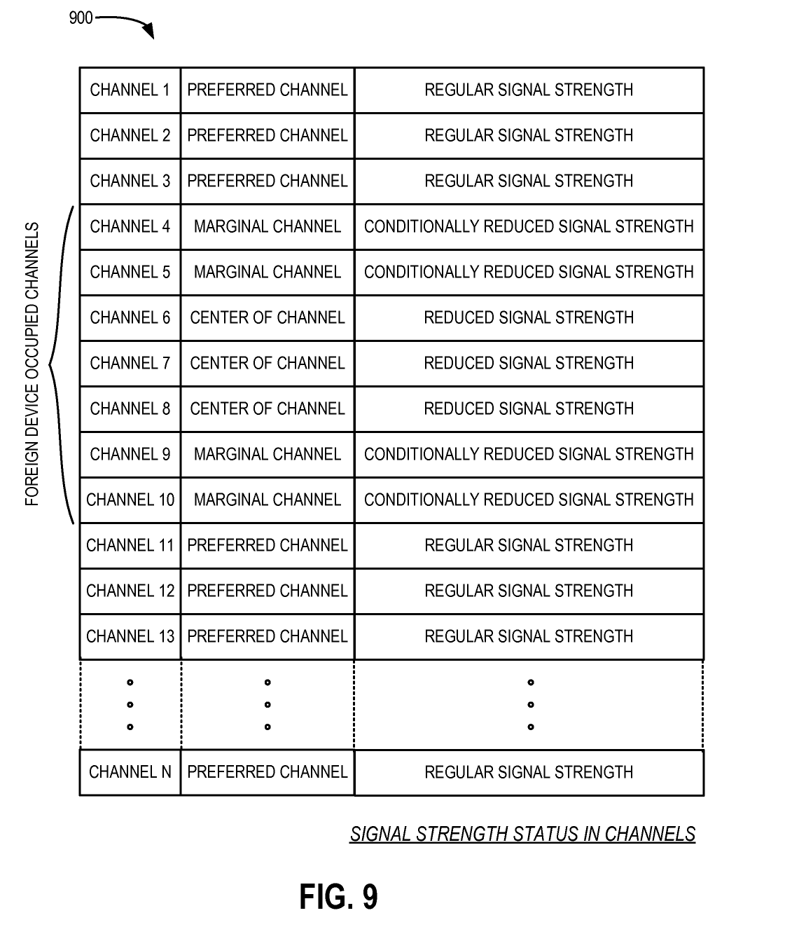

FIG. 7A is block diagram 700 that illustrates an example where Radio Frequency RFID reader system component 701 co-exists with other ISM-band devices like foreign spread spectrum device 1 712 and foreign spread spectrum device 2 714. RFID reader system 701 communicates with RFID tags 703 using a frequency spectrum portion subdivided into a set of channels. The communication takes place in the presence of foreign devices 712 and 714 such a way that RFID reader system 701 uses the subset of channels of the spectrum that are not in use by foreign devices 712 and 714. A radiating power directed towards the tag, in the channels used by the foreign devices, may be reduced and a radiating dwell time may be shortened. The subsets used by the RFID readers are referred to as preferred channels (PC).

RFID reader system 701 includes application 702 and one or more of the readers 704 through 710. Application 702 communicates with RFID readers 704 through 710 via a wire. RFID readers can communicate with each other in a limited way via a wire or wirelessly. These RFID readers are also capable of wirelessly communicating with non-RFID foreign devices 712 and 714 in a very limited way, if at all.

Having RFID reader system 701 set up for operating only with one RFID reader e.g. RFID reader 704, does not preclude other RFID readers to join in. A new reader can join in after recognizing the pattern of RFID reader 704, and can start transmission on preferred channels.

Before RFID system 701 starts communicating with tags 703, application 702 according to comment 716 configures a list of preferred channels and communicates it to the RFID reader for respecting foreign devices. To create the list of preferred channels requires that the presence of a foreign device and its channel use are determined. This determination can be done both manually and automatically.

In the manual mode, an operator tells the application of the presence of a foreign device and its channel use.

In the automatic mode, the creation of the list of preferred channels is based on results of an RFID reader occasionally checking for a foreign device. The checking is performed by listening to foreign devices, as indicated by comment 718, and analyzing a received RF wave energy. Alternately, the checking is performed by analyzing a received RF wave signal modulation. Another way of checking involves an RFID reader to transmit a unique interrogation signal to a foreign device and to determine a presence of a foreign device and its channel use from a received response. Yet another way entails, according to note 720, a reader to listen to other reader's transmission patter and to start transmission in the same preferred channels.

The invention also includes methods. Some are methods of operation of an RFID reader or RFID reader system. Others are methods for controlling the RFID reader or the RFID reader system. These methods can be implemented in any number of ways, including the structures described in this document. One such way is by machine operations of devices of the type described in this document.

Another optional way is for one or more individual operations of the methods to be performed in conjunction with one or more human operators performing some of them. These human operators need not be collocated with each other, but each can be only working with a machine that performs a portion of the program.

FIG. 7B is flowchart 740 that illustrates methods for operating an RFID reader system along with co-existing other ISM-band devices according to embodiments of the present invention.

At optional operation 742, the RFID reader configuration is adjusted for respecting a foreign device. Four different aspects of the RFID reader configuration are the subject of adjustment. They are, a number of channels allocated for foreign devices, a hopping sequence, a radiation power level for each channel, and a channel dwell time for every hop. In order to allow a foreign device to co-exist with the RFID reader, the RFID reader reduces transmission power in the channels used by the foreign device. In one of the embodiments, there is an upper limit of sixteen channels that may be allocated to foreign devices.

At next operation 744, a hopping sequence and RFID transmission dwell times are defined.

At next operation 746, a channel is selected for the next RFID transmission.

At next operation 748, the dwell time is set for RFID transmission.

At next operation 750, the RFID radiation power level is set for the channel.

At next optional operation 752, the RFID reader performs tag inventory in the selected channel, then the method may loop back to operation 746.

FIG. 7C is flowchart for operation 742 that illustrates different methods of adjusting the RFID reader configurations for foreign devices in the ISM-band according to embodiments of the present invention. The method of the flowchart of FIG. 7C may be practiced by different embodiments, including but not limited to other embodiments described in this document.

At operation 760, a RFID reader pre-configuration setting is loaded based on an operator input.

At optional operation 762, the RFID reader setting is based on a communication with the application over a wire.

At optional operation 764, the RFID reader setting is based on a wireless communication from another reader.

At optional operation 766, the RFID reader setting is based on a communication with another reader over a wire.

At optional operation 768, the RFID reader searches for a foreign device in order to determine a required configuration setting.

FIG. 7D is flowchart for operation 750 that illustrates different methods of setting a radiation power level for the channels occupied by the foreign device according to embodiments of the present invention.

At optional operation 772, the power level setting is based on a feedback from the foreign device.

At optional operation 774, the power level setting is base on a measured signal strength of the foreign device.

At optional operation 776, the power level is set to a predetermined value. The predetermined value is a function of the foreign device's characteristics, the characteristic being a strength and/or a modulation of a RF signal from the foreign device. The power level of can be zero for sensitive low power foreign devices or it maybe zero dBm in another applications, but in no case should it be more than 90% of the regular RFID power level.

FIG. 7E is flowchart for operation 768 that illustrates different methods of searching for a foreign device in the ISM-band according to embodiments of the present invention.

At optional operation 782, the searching for the foreign device analyses a received RF wave energy level from the foreign device.

At optional operation 784, the searching for the foreign device analyses the received RF wave signal modulation from the foreign device

At optional operation 786, the searching for the foreign device transmits a special interrogation signal toward the foreign device.

At next optional operation 788, the presence and channel use of the foreign device are determined form the response of the foreign device.

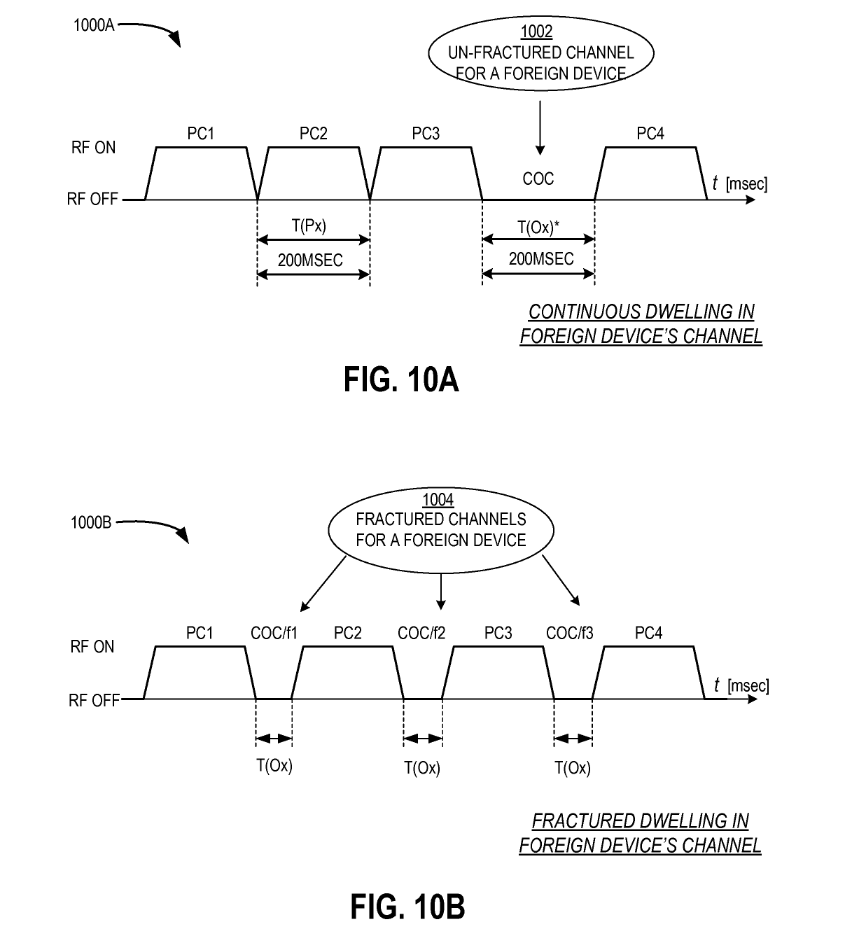

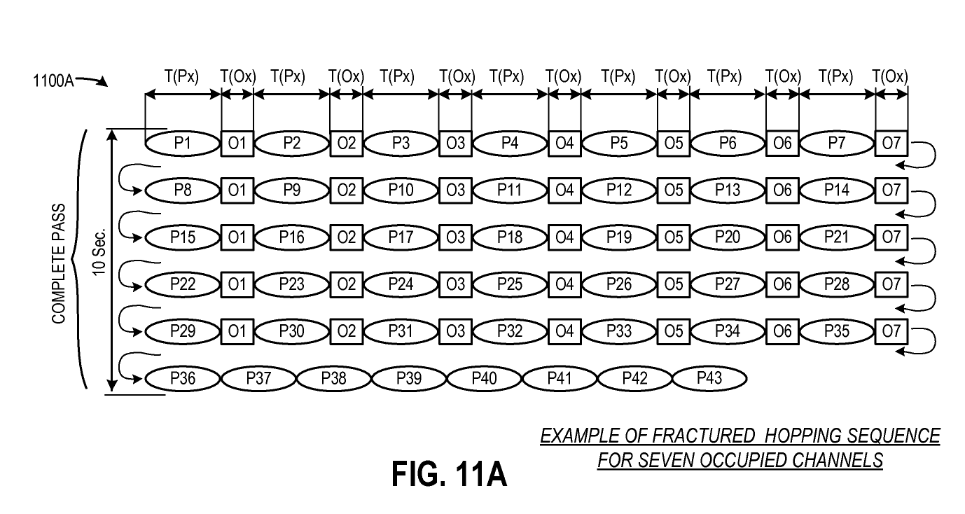

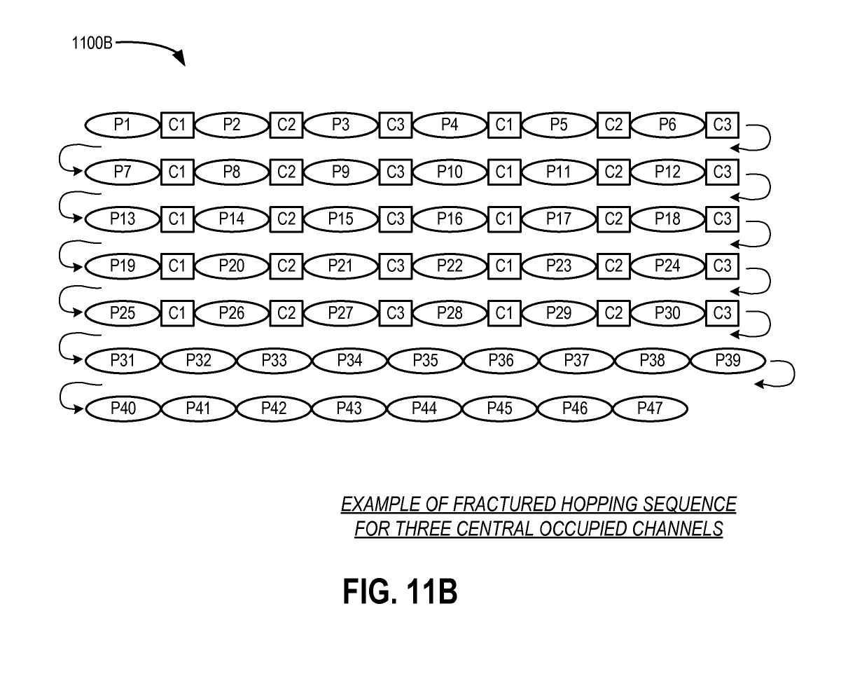

FIG. 8A is diagram 800A that illustrates an example of channel distribution in subsets of the RF spectra according to prior art. In North America the governing body is the Federal Communications Commission (FCC). The FCC allocates and regulates the spectrum for different usages. The FCC has allocated the frequency band between 902-928 MHz for Industrial Scientific & Medical (ISM) use. This ISM band is the RF spectrum UHF RFID readers are allowed to operate in. As the name ISM suggests, this band is not an exclusive domain of the UHF RFID readers. UHF RFID readers share this band with other devices. The ISM band is divided into 50 channels. The FCC ISM rules require frequency-hopping devices, i.e. RFID readers to use these 50 channels, spaced 500 kHz apart.

FIG. 8B is diagram 800B that illustrates an example of channel use by a foreign spread spectrum device according to an embodiment of the present invention. The FCC ISM rules allow spread-spectrum devices to spread their signal energy across a subset of channels in the ISM band, without hopping. Diagram 800B shows that the foreign device uses seven channels, channels 4 through 10 out of the available 50. A typical spread-spectrum system works normally using seven channels, but it is capable of operating with three channels in a somewhat degraded fashion. To recognize this characteristic of the spread spectrum device, the three central channels of the seven channel spectrum are designated as center of channel (COC), or central channel, while the four channels surrounding the COC are designated as marginal channels (MC). Typically, foreign device is more susceptible to interference in the central channels than in the marginal channels. It should be noted, COC and MC may be referred to as occupied channels, and terms COC and “central channel” are used interchangeably in this disclosure.

FIG. 8C is diagram 800C that illustrates an example of an RFID reader's channel use while respecting a foreign device according to an embodiment of the present invention. In order to allow the spread spectrum foreign device to operate the RFID reader reduces transmission energy levels in the occupied channels. All occupied and preferred channels comply with 15.247 FHSS regulations, which require that “Each frequency must be used equally on the average by each transmitter”. As FIG. 800C illustrates, the RFID reader can transmit at each channel. The power in the occupied channels can be reduced by 10% or more than in the unoccupied, or preferred channels, at least as averages. In some embodiments, the RFID reader transmits a regular RFID signal at full power level in the preferred channels. Since the foreign device is more susceptible to interference in the COCs than in the MCs, RFID reader can transmits at a reduced power level, and the transmission is typically a CW. The transmission power level and the transmission content in a MC depend on operation circumstances. Typically, a MC is treated in the same way as a COC. When tag-reading difficulties demand it the MC maybe treated as a preferred channel.

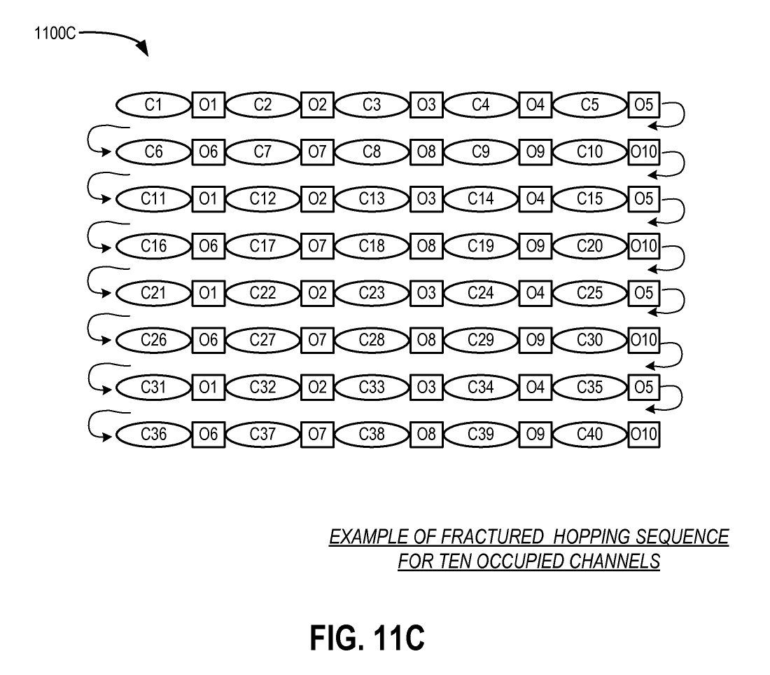

FIG. 9 is table 900 that illustrates a signal strength status of example 800C of FIG. 8C in shared ISM channels according to an embodiment of the present invention. Table 900 shows that in COCs, channels 6-8, signal strengths are reduced, while in MCs, channel 4-5 and 9-10, signal strengths are conditionally reduced. In the preferred channels, channels 1-3 and 11-N, there are regular signal strengths.

To accomplish reductions of signal strengths in the occupied channels the RFID reader transmits at a reduced power level in the occupied channels. The reduced power level maybe set at zero dBm, or it maybe set at zero (the RFID reader does not transmit at all).

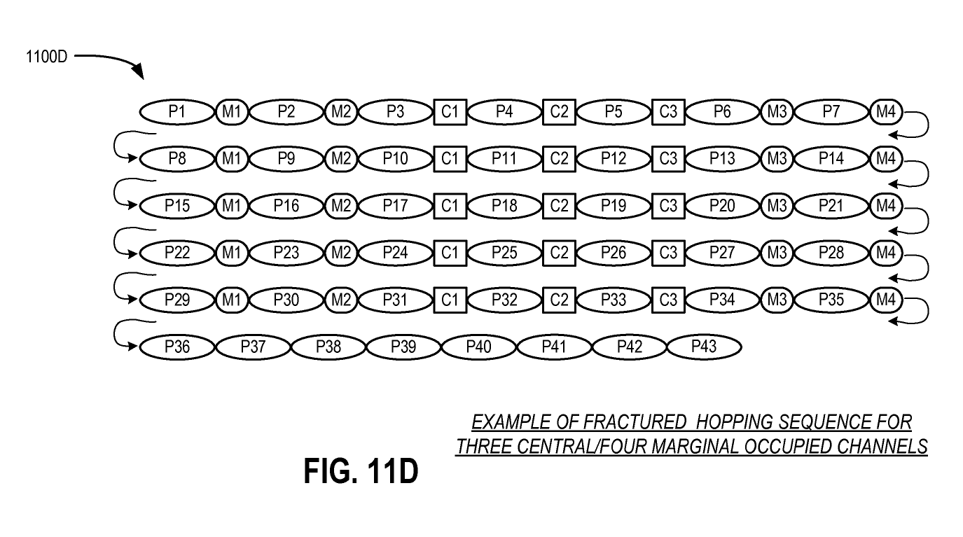

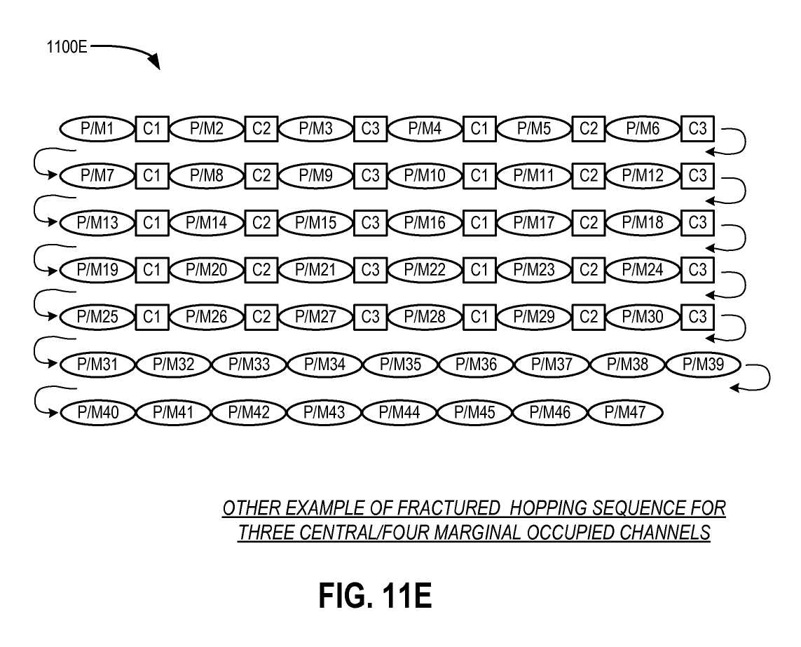

FIG. 10A is timing diagram 1000A that illustrates an example of a continuous dwelling in an occupied channel according to an embodiment of the present invention.

In order to appreciate the operating parameters one needs to look at the relevant regulation 15.247 FHSS that states: “The system shall hop to channel frequencies that are selected at the system hopping rate from a pseudo randomly ordered list of hopping frequencies.

For frequency hopping systems operating in the 902-928 MHz band: if the 20 dB bandwidth of the hopping channel is less than 250 kHz, the system shall use at least 50 hopping frequencies and the average time of occupancy on any frequency shall not be greater than 0.4 seconds within a 20 second period; if the 20 dB bandwidth of the hopping channel is 250 kHz or greater, the system shall use at least 25 hopping frequencies and the average time of occupancy on any frequency shall not be greater than 0.4 seconds within a 10 second period.”

Given the above rule, dwell times are set to 200 msec. Diagram 1000A shows that preferred channels PC1-4 and center of channel COC are used for a continuous dwelling of 200 msec. This arrangement of dwell times does work, but it is far from optimum. For example if there are seven occupied channels and channel dwelling in the occupied channels are contiguous the RFID reader can miss some tags that are moving through a portal. To avoid the above scenario, it is advantageous to fragment dwelling in the occupied channels.

FIG. 10B is timing diagram 1000B that illustrates an example of a fractured dwelling in an occupied channel according to an embodiment of the present invention.

In diagram 1000B un-fractured channel dwell time T(Ox)* 1002 of FIG. 10A is fractured according to note 1004. In the given example, COC's dwell time T(Ox)* is fractured into three noncontiguous fragments COC/f1, COC/f2, and COC/f3 with dwell time of T(Ox).

The duration of a fractured dwell time can be determined by the following algorithm:
The number of available channels is 50, the number of occupied channels is N and the average dwell time is 200 msec.
Compute number of preferred channel: PCN=50−N; (This is also the number of intervals between preferred channels, where a reduced power occupied channel may be inserted.) Compute integer ratio of full power channels over reduced power
channels: R=(50−N)/N;
Find R′ such that R′<=R and (200 mod R′)=0; (R′ is the number of hops on the same occupied channel over a 10 s time-window);
Compute a dwell time T(Ox) for each occupied channels: T(Ox)=200/R′.

As a result of different fragmentation processes, an average dwell time in one of the occupied channels varies, and can be between two and twenty times shorter than an average dwell time in one of the prefer channels.

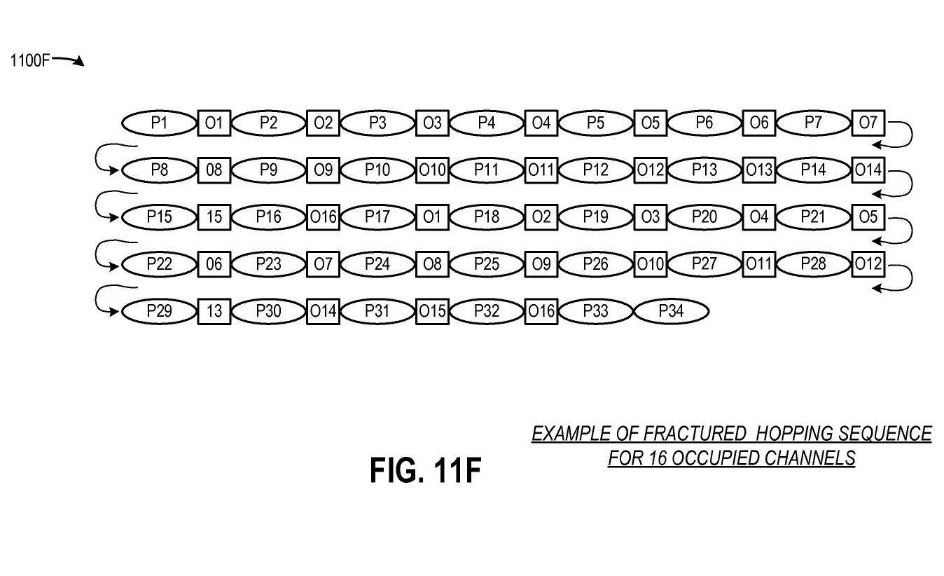

FIGS. 11A-F are diagrams 1100A through 1100F that illustrate examples of various fractured hopping sequences according to embodiments of the present invention. In the diagrams objects labeled as P1, P2, Pxx represent preferred channels, objects labeled as O1, O2, Oxx represent central & marginal (Occupied) channels, objects labeled as C1, C2, Cx represent central channels, objects labeled as M1, M2, Mx represent marginal channels, and objects labeled as P/M1, P/M2, P/Mxx represent either preferred and marginal channels. It should be further noted that numerals in a label do not imply any particular hopping sequence, rather they represent the uniqueness of a channel.

Channel hopping is performed according to two pseudo randomly ordered lists. A list is created for the preferred channels and a separate list for the occupied channels. The two lists are interspersed in such a way that a preferred channel is followed immediately by an occupied channel, which is followed immediately by a preferred channel and so on. This interspersion of the list is followed until the total dwell time of each of the occupied channels equals the dwell time of a preferred channel.

Alternatively, the method of channel hopping in the preferred channel follows the randomly ordered list, while hopping into an occupied channel proceeds according to the channel numbers.

The above-described channel hopping sequences alternate radiation of the RFID reader between the occupied channels and the preferred channels.

FIG. 11A is diagram 1100A that illustrates an example of fractured hopping sequence that accommodates seven occupied channels according to an embodiment. In the given example, during a complete pass of 10 sec, each of the preferred channels are radiated in once for 200 msec, T(Px)=200 msec, while each of the seven occupied channels are radiated in five times for 40 msec, T(Ox)=40 msec, at each occasion.

Radiation alternates between preferred and occupied channels until it reaches radiation sequence P36, from then on, until the completion of the pass only preferred channels are radiated in.

FIG. 11B is diagram 1100B that illustrates an example of fractured hopping sequence that accommodates three occupied channels according to an embodiment. In the given example, during a complete pass each of the three occupied channels is radiated in ten times for 20 msec at each occasion. Radiation alternates between preferred and occupied channels until radiation sequence P31 is reached, from then on, until the completion of the pass only preferred channels are radiated in.

FIG. 11C is diagram 1100C that illustrates an example of fractured hopping sequence that accommodates ten occupied channels according to an embodiment. In the given example, during a complete pass each of the ten occupied channels is radiated in four times for 50 msec at each occasion.

FIG. 11D is diagram 1100D that illustrates an example of fractured hopping sequence that accommodates three central channels, however it uses four fractured marginal channels according to an embodiment. In the given example, during a complete pass, each of the tree central and each of the four marginal channels are radiated in five times for 40 msec at each occasion. Radiation alternates between preferred and occupied channels until radiation sequence P36 is reached, from then on until the completion of the pass, only preferred channels are radiated in. The difference between FIG. 11A and FIG. 11D is that in FIG. 11D marginal channels M1-M4 are radiated in with regular RFID power level.

FIG. 11E is diagram 1100E that illustrates another example of fractured hopping sequence that accommodates three central channels, however it uses four marginal channels for regular RFID radiation according to an embodiment. In the given example, during a complete pass each of the tree central channels are radiated in ten times for 20 msec at each occasion, while marginal channels are treated as preferred channels. Radiation alternates between preferred/marginal and central channels until radiation sequence P36 is reached, from then on, until the completion of the pass only preferred/marginal channels are radiated in.

FIG. 11F is diagram 1100F that illustrates an example of fractured hopping sequence that accommodates sixteen occupied channels according to an embodiment. In the given example, during a complete pass each of the sixteen occupied channels is radiated in two times for 100 msec at each occasion.

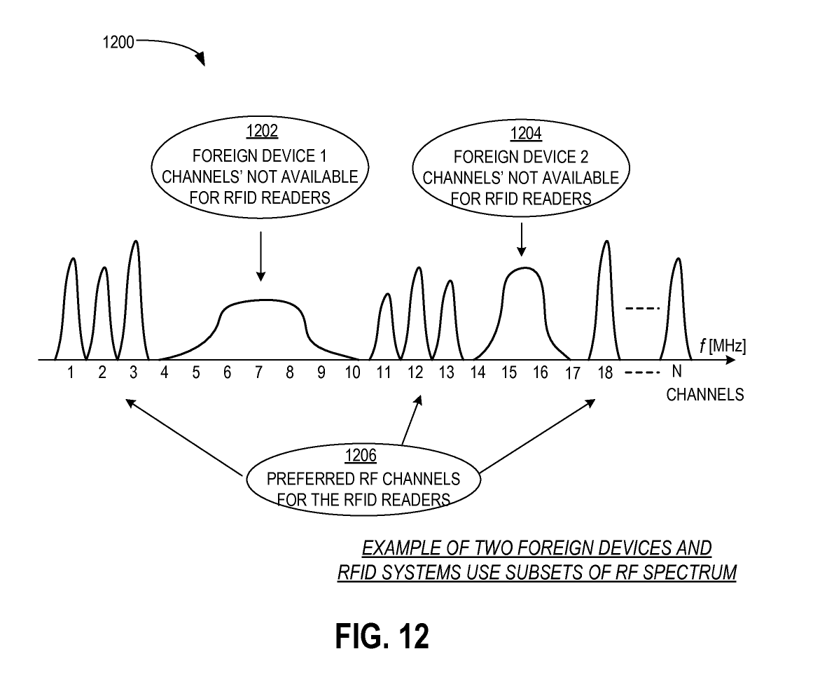

FIG. 12 is diagram 1200 that provides a spectral view of an RF environment of FIG. 7 where many RFID readers co-exist with two spread-spectrum foreign devices, foreign device 1 and foreign device 2. The RFID readers and the foreign devices use different subsets of the RF spectrum. According to notes 1202 and 1204, channels 4 through 10 and 14 through 17 are not available for regular RFID reader operation. While, according to note 1206, the rest of the channels are preferred channels for the RFID readers.

Numerous details have been set forth in this description, which is to be taken as a whole, to provide a more thorough understanding of the invention. In other instances, well-known features have not been described in detail, so as to not obscure unnecessarily the invention.

The invention includes combinations and subcombinations of the various elements, features, functions, and/or properties disclosed herein. The following claims define certain combinations and subcombinations, which are regarded as novel and non-obvious. Additional claims for other combinations and subcombinations of features, functions, elements, and/or properties may be presented in this or a related document.

1.-25. (canceled)

26. A method for an RFID reader to communicate with a plurality of RFID tags using frequency-hopping spread spectrum (FHSS), comprising:
retrieving a power level for each FHSS channel, wherein a first power level for a preferred FHSS channel is substantially greater than a second power level for an occupied FHSS channel; and
transmitting in each of the FHSS channels such that a total dwell time in the preferred channel is substantially the same as the total dwell time in the occupied channel during a complete pass, wherein the transmission in the preferred channel is at the first power level and the transmission in the occupied channel is at the second power level.

27. The method of claim 26, wherein the power level for each FHSS channel is retrieved from at least one from a set of: a locally stored table, a remotely stored table, a network, and another RFID reader.

28. The method of claim 26, further comprising:
fracturing a hopping sequence by hopping to the occupied channel at a substantially higher rate and with a substantially shorter dwell time than to the preferred channel, wherein a total dwell time in the occupied channel is still substantially the same as the total dwell time in the preferred channel during a complete pass.

29. The method of claim 28, wherein the fracturing of the hopping sequence is determined based on comparing a number of occupied channels to a number of preferred channels available during the complete pass.

30. The method of claim 26, wherein occupied channels include one or more central channels and one or more marginal channels, and the method further comprises:
transmitting in the central channels at the second power level and in the marginal channels at a third power level, the third power level being lower than the first power level and higher than the second power level.

31. A method for an RFID reader to communicate with a plurality of RFID tags using frequency-hopping spread spectrum (FHSS), comprising:
determining a power level for each FHSS channel, wherein a first power level for a preferred FHSS channel is substantially greater than a second power level for an occupied FHSS channel; and
transmitting in each of the FHSS channels such that a total dwell time in the preferred channel is substantially the same as the total dwell time in the occupied channel during a complete pass, wherein the transmission in the preferred channel is at the first power level and the transmission in the occupied channel is at the second power level.

32. The method of claim 31, wherein determining the power level for each FHSS channel comprises:
listening for an RF signal in an FHSS channel; and
if the RF signal is determined to be from a foreign device, designating the FHSS channel as an occupied channel.

33. The method of claim 32, wherein determining whether the RF signal is from a foreign device is based on at least one of a strength and a modulation of the RF signal.

34. The method of claim 32, wherein determining the power level for each FHSS channel further comprises analyzing a feedback from the foreign device.

35. The method of claim 34, further comprising:
transmitting a unique interrogation signal to the foreign device;
determining a presence of the foreign device from a received feedback; and
determining one or more FHSS channels being occupied by the foreign device.

36. The method of claim 31, wherein determining the power level for each FHSS channel further comprises communicating with another reader over a wire.

37. The method of claim 31, further comprising:
fracturing a hopping sequence by hopping to the occupied channel at a substantially higher rate and with a substantially shorter dwell time than to the preferred channel, wherein a total dwell time in the occupied channel is still substantially the same as the total dwell time in the preferred channel during a complete pass.

38. The method of claim 37, wherein the fracturing of the hopping sequence is determined based on comparing a number of occupied channels to a number of preferred channels available during the complete pass.

39. The method of claim 31, wherein occupied channels include one or more central channels and one or more marginal channels, and the method further comprises:
transmitting in the central channels at the second power level and in the marginal channels at a third power level, the third power level being lower than the first power level and higher than the second power level.

40. An RFID reader for communicating with a plurality of RFID tags using frequency-hopping spread spectrum (FHSS), comprising:
a communication module; and
a processing block coupled to the communication module, wherein the processing block is configured to:
determine a power level for each FHSS channel, wherein a first power level for a preferred FHSS channel is substantially greater than a second power level for an occupied FHSS channel; and
transmit in each of the FHSS channels such that a total dwell time in the preferred channel is substantially the same as the total dwell time in the occupied channel during a complete pass, wherein the transmission in the preferred channel is at the first power level and the transmission in the occupied channel is at the second power level.

41. The RFID reader of claim 40, wherein the processing block is further configured to:
determine the power level for each FHSS channel by retrieving power-level information from at least one from a set of: a locally stored table, a remotely stored table, a network, and another RFID reader.

42. The RFID reader of claim 40, wherein the processing block is further configured to:
monitor each FHSS channel to detect a presence of a transmitting foreign device.

43. The RFID reader of claim 40, wherein the processing block is further configured to:
fracture a hopping sequence by hopping to the occupied channel at a substantially higher rate and with a substantially shorter dwell time than to the preferred channel, wherein a total dwell time in the occupied channel is still substantially the same as the total dwell time in the preferred channel during a complete pass.

44. The RFID reader of claim 43, wherein the fracturing of the hopping sequence is determined based on comparing a number of occupied channels to a number of preferred channels available during the complete pass.

45. The RFID reader of claim 40, wherein occupied channels include one or more central channels and one or more marginal channels, and the processing block is further configured to:
transmit in the central channels at the second power level and in the marginal channels at a third power level, the third power level being lower than the first power level and higher than the second power level.
